(19) United States
(12) Patent Application Publication
(10) Pub. No.: US 2009/0216996 A1
(43) Pub. Date: Aug. 27, 2009

(54) Parallel Processing

(75) Inventors: Daniel James Goodman, Oxford (GB); Raphael Andreas Hauser, Oxford (GB)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: Isis Innovation Limited

(21) Appl. No.: 12/390,167

(22) Filed: Feb. 20, 2009

(30) Foreign Application Priority Data
Feb. 22, 2008 (GB) 0803238.5

(51) Int. Cl. G06F 9/38; G06F 15/76; G06F 9/02

(52) U.S. Cl. 712/28; 712/233; 709/201; 712/E09.002; 712/E09.045

(57) ABSTRACT

A system and methods comprising a plurality of leaf nodes in communication with one or more branch nodes, each node comprising a processor. Each leaf node is arranged to obtain data indicative of a restriction A|_{IS} of a linear map from Rⁿ to R^{m} represented by a first matrix, A, to a subspace IS of Rⁿ and to carry out a calculation of data indicative of at least a leading part of the SVD of a matrix representation of the restriction A|_{IS}. One or more of the plurality of leaf nodes or branch nodes is arranged to use results of the calculations to compute data indicative of a subspace OS of each node input subspace IS and to pass that data and a corresponding restriction A|_{OS} of A to one of a plurality of the one or more branch nodes. Each of the one or more branch nodes is arranged to receive data indicative of node output spaces OS₁, . . . , OSₖ and the corresponding restrictions A|_{OS1}, . . . , A|_{OSk} for k≧2, to use this data to form a further node input space IS=OS₁+ . . . +OSₖ, and to carry out a further calculation indicative of the leading part of the SVD of a matrix representation of a further restriction A|_{IS}, of the linear map A to the further node input space IS. One or more of the one or more branch nodes is arranged to these results of the further calculations to compute data indicative of a further node output space OS of the further node input space IS and, if further processing of the data indicative of a further node output space OS is required, to pass the data indicative of the further node output space OS and a corresponding restriction A|_{OS} of A to one or a plurality of the one or more branch nodes.

### CROSS-REFERENCE TO RELATED PATENT APPLICATIONS

Great Britain Priority Application 0803238.5, filed Feb. 22, 2008 including the specification, drawings, claims and abstract, is incorporated herein by reference in its entirety.

### BACKGROUND OF THE INVENTION

This invention relates to a system and method of parallel processing to determine at least a leading part of a singular value decomposition (henceforth referred to as SVD) of a matrix. The invention has particular, but not exclusive, application to distributed processing across multiple computer systems and processing on a computer having multiple processors, such as multiple CPUs or a multi-core CPU.

The SVD is the main mechanism behind dimension-reduction techniques such as principle component analysis (PCA) and certain approaches to model reduction in control systems.

Previous methods for computing an SVD do not extend well to environments where all of a plurality of resources cannot be guaranteed to progress at the same rate and have a high-bandwidth low-latency communication system. As such, computing an SVD of data spanning multiple resources is computationally expensive when using existing methods.

The full SVD of a matrix A is a factorisation where the matrix is broken down into three matrices, U, Σ and V^{T}, such that

A=UΣV^{T},

where A is of size m×n, U is an orthogonal matrix of size m×m, E is a m×n diagonal matrix that contains nonnegative non-increasing entries down the diagonal (these values are called the singular values of A), and V is an orthogonal matrix of size n×n, the column vectors of which are called the singular vectors of A. Since the matrix A can be interpreted as representing a linear map from Rⁿ to R^{m} one can also think of the SVD as identifying an orthogonal basis of the preimage space Rⁿ, given by the column vectors of V, such that the images in R^{m} of these vectors under the mapping A remain orthogonal with directions given by the columns of U and lengths given by the diagonal entries of Σ.

The SVD is of interest because it identifies amongst all p dimensional subspaces in the preimage of A (interpreted as a linear map), the subspace on which a unit volume element is most inflated under the action of A. The inflation factor can be inferred from A, while a basis of the said subspace can be read off from V. This property can be used to remove the less significant information from the mapping represented by the matrix A. To do this, the SVD is calculated and then all but the p largest entries of Σ are zeroed for a chosen 0≦p≦min (m,n). Then the matrices are multiplied back together to produce a rank-p matrix that represents the closest approximation of A by a mapping of rank-p, where distance is measured in terms of the operator norm induced by the Euclidean norm. In many areas of science and engineering this rank reduction mechanism is used to represent high-dimensional data by low-dimensional approximations that are qualitatively very similar. This technique is frequently applied in the analysis of climate and weather data, in image processing (facial recognition, image compression, image deblurring etc.), data compression, finance (determine market-driving factors, covariance estimation techniques, finding locally-defined functional dependences between parameters etc.), model reduction for high-dimensional control systems, signal processing (noise reduction, multichannel fluctuation data analysis in fusion plasma devices etc.), in the regularisation of inverse problems, in solving linear least squares problems (used in linear regression, computing pseudoinverses of linear operators, computer tomography, geophysical inversion, seismology, oil exploration, fault diagnosis, medical imaging etc.), in pattern recognition, spectroscopy (analysis of time-resolved macromolecular x-ray data, small-angle scattering, etc.), modal analysis (vibration reduction, sound engineering etc.), information retrieval, latent semantic indexing, construction of search engines, detection of computer network attacks, microarray analysis, functional clustering, analysing gene expression profiles, gene recognition, molecular dynamics, solving systems of homogeneous linear equations, preconditioning of linear systems, determining dependencies or near-dependencies among the columns or rows of a matrix (used by optimisation software in the preprocessing of constraints in linearly constrained optimisation problems), and in numerous other contexts.

The matrices that occur in applications can be extremely large, and it is often not feasible to calculate, even with the help of computers, the complete SVD of the matrix, as this entails generating an extremely large data set that can be significantly larger than the original dataset, and excessive computation time. However, the p-leading part of the SVD of A (the p largest singular values along with the corresponding parts of U and V) can be computed directly, without the need for computing the full SVD of A.

### Previous Methods

Lanczos' and related methods provide iterative techniques for calculating the leading part of the SVD of a matrix in which parts of the calculation can be processed in parallel on a regular network of processors. After each iteration step of any of these techniques, a significant number of processors have to communicate information to each other on the current results of the iteration before carrying out the next iteration step. This means that processors are interlocked at every iteration step. Such interlocking means that communication latency and waiting for processors to synchronise will be a limiting factor on the speed of processing, and failure of processors can result in severe delays in processing. This may, in practical terms, prohibit such parallel processing over a distributed network, such as the Internet, or a data centre, wherein the speed of communication is significantly lower than the processing speed of a processor, and the processors may be highly heterogeneous in nature, resulting in processors that may progress at very different speeds. Even in parallel processing environments on non-distributed systems, communication latency can be the over-riding limiting factor on processing speed, with communication speeds far lower than CPU speeds.

### SUMMARY OF THE INVENTION

According to a first aspect of the invention there is provided a system comprising a plurality of leaf nodes in communication with one or more branch nodes, each node comprising a processor, each of the plurality of leaf nodes arranged to obtain data indicative of a restriction A|_{IS} of a linear map from Rⁿ to R^{m} represented by a first matrix, A, to a subspace IS of Rⁿ (henceforth referred to as a node input space), and to carry out a calculation of data indicative of at least a leading part of a SVD of a matrix representation of the restriction A|_{IS}, one or more of the plurality of leaf nodes and the one or more branch nodes being arranged to use results of the calculations carried out by the plurality of leaf nodes to compute data indicative of a subspace OS (henceforth referred to as a node output space) of the node input space IS, and to pass the data indicative of node output space OS and a corresponding restriction A|_{OS} of A to one or a plurality of the branch nodes, each of the one or more branch nodes arranged to receive data indicative of node output spaces OS₁, . . . , OS_{κ} and the corresponding restrictions A|_{OS1}, . . . , A|_{OSκ} for k≧2, to use this data to form a further node input space IS=OS₁+ . . . +OSₖ, and to carry out a calculation of data indicative of the leading part of the SVD of a matrix representation of a further restriction A|_{IS} of the linear map A to the further node input space IS, and one or more of the one or more branch nodes arranged to use the results of the calculations carried out by the one or more branch nodes to compute data indicative of a further node output space OS of the further node input space IS and, if further processing is required, to pass the data indicative of the further node output space OS and a corresponding restriction A|_{OS} of the linear map represented by A to one or a plurality of the one or more branch nodes.

The system of the invention may be advantageous as it can approximate the SVD of a matrix A and its associated linear mapping by distributing the processing across a plurality of leaf nodes and one or more branch nodes, with each node carrying out calculations independently of the other nodes once it has received its input data. In this way, the nodes are not interlocked, with each node being able to complete a calculation on a space IS without having to wait for a prespecified set of other nodes to complete their calculations. As a result, communication between nodes is reduced and in some cases eliminated, reducing delays due to communication latency.

In one embodiment the node input space IS of a leaf node is represented via an orthogonal basis given by the columns of a Stiefel matrix Qᵢₙ of size n×1 (for Q to be Stiefel it is required that Q^{T}Q is an identity matrix) and data indicative of the restriction A|_{IS} is represented by a matrix Wᵢₙ that approximates the product AQᵢₙ. For example, if IS is spanned by a subset of the coordinate vectors in Rⁿ, then Wᵢₙ consists of a sub-matrix of A given by juxtaposing a subset of columns of A. In this embodiment the leaf node may be arranged to calculate the q-leading part USV^{T} of the SVD of Wᵢₙ for q≧1, and determine the node output space OS via an orthogonal basis given by the columns of the Stiefel matrix Qₒᵤₜ=Qᵢₙ V, and the restriction A|_{OS} by the matrix Wₒᵤₜ=Wᵢₙ V, approximating AQₒᵤₜ.

In one embodiment the or each branch node is arranged to receive n×qᵢ matrices Qⁱₒᵤₜ, for I=1 . . . k, that represent the node output spaces OSⁱ=span(Qⁱₒᵤₜ) of the leaf and/or branch nodes from where the input data of the current branch node are received, and m×qᵢ matrices Wₒᵤₜⁱ, for I=1 . . . k, representing the restriction A|_{OS}_{ⁱ} by approximating AQₒᵤₜⁱ. Two new matrices Qᵢₙ=diag (Qₒᵤₜ¹, . . . , Qₒᵤₜ^{k}) and Wᵢₙ=[Wₒᵤₜ¹, . . . , Wₒᵤₜ^{k}] are then formed, where Qᵢₙ is block-diagonal with blocks Qₒᵤₜⁱ. The branch node is the arranged to determine a q-leading part USV^{T} of the SVD of Wⁱⁿ for q≧1, where 1=q₁+ . . . +qₖ, and the QR-decomposition QₒᵤₜR of the product of matrices [1, . . . , 1]Qᵢₙ V, where 1 are identity matrices of size n. The branch node output space OS is then represented via the orthogonal basis given by the columns of the Stiefel matrix Qₒᵤₜ, and the restriction A|_{OS} is represented by the matrix Wₒᵤₜ=Wᵢₙ VR⁻¹, approximating AQₒᵤₜ.

The use of node subspaces and restrictions on A thereon represented by matrices Q and W is an effective way of merging data on SVDs sent to the branch nodes such that further calculations can be carried out on the merged data to progress towards an approximation of the SVD of the first matrix A without requiring further data from predeceasing leaf and/or branch nodes. In this way, once the branch node has received the data on SVDs calculated earlier, no further communication (which could result in delays in processing) is required between the branch node and the predeceasing leaf and/or branch nodes from which it receives data.

The combination of data Wₒᵤₜⁱ, . . . , Wₒᵤₜ^{k} and Qₒᵤₜⁱ, . . . , Qₒᵤₜ^{k} received by a branch node is advantageous, as it may only be necessary for the branch node to pass on the output data Wₒᵤₜ, Qₒᵤₜ reflecting the combined data to other branch nodes for further processing rather than all the data Wₒᵤₜⁱ, . . . , Wₒᵤₜ^{k} and Qₒᵤₜⁱ, . . . , Qₒᵤₜ^{k}. In this way, communication delays may be reduced, and the complexities of handling many nested data structures may be avoided.

Each leaf or branch node may be arranged to calculate a predetermined, user specified or dynamically adjusted number, q≧dim (IS), of leading vectors of the SVD of a matrix representation of the restriction A|_{IS} of the linear map corresponding to the first matrix A to the node input space IS. Using a flexible value of q may be advantageous in speeding up the overall computations, in that adaptive values may be chosen so as to first compute an approximation of the q leading singular vectors of the first matrix A for q<p and to implicitly use this data to warm-start the calculation of the p-leading part of the SVD of A. In one embodiment q is equal to p at all nodes.

The data flow between leaf and branch nodes may be arranged in a directed (network) graph structure. We call an extraction node any node occurring in a position in the graph to which data from many leaf nodes can flow and be extracted from the system. In one embodiment, the graph structure is constructed as a directed tree, the root of which is the unique extraction node reached by data from all leaf nodes.

It is possible to arrange the system in a tree structure because each node can complete the processing of its input data to produce output data independently of calculations carried out by other nodes. Systems that operate in accordance with a tree structure may be advantageous as failure of a node on one branch does not prevent nodes on other branches of the tree from completing tasks allocated to them. In this way, delays due to failure of nodes in the system may be reduced and the system has increased resiliency to node failure.

An evaluation node, comprising a processor, may be arranged to receive data indicative of the node output space OS of an extraction node and the restriction A|_{OS} of the linear map represented by the first matrix A to this space, and to calculate an approximation of the p-leading part of the SVD of A, with p≧dim(OS).

In one embodiment, the output data of an extraction node is received by the evaluation node in the form of matrices Wₒᵤₜ, Qₒᵤₜ consistent with the embodiment of leaf and branch nodes described earlier. The evaluation node may be arranged to determine a p-leading part UΣ\tilde{V}^{T} of the SVD of Wₒᵤₜ, the factors U, Σ and V=Qₒᵤₜ \tilde{V} being presented as the factors of the approximate p-leading part of the SVD of the first matrix A.

Each processor may operate as one or more node(s), for example a processor may operate as one or more node selected from the group of leaf nodes, branch nodes, root node, evaluation node and extraction nodes. Furthermore, each node may comprise more than one processor. For example, computer resources may be available to the system for carrying out general functions, such as calculation of an SVD of a matrix, summation of output node spaces, etc. These computer resources can be called by a processor of the system and the computer resource returns a value to that processor. Accordingly, parts of the calculation carried out by a node may be outsourced to one or more of these “general function” computer resources and each “general function” computer resource may perform part of the calculation carried out by one or more nodes.

As each node is arranged to carry out an internal SVD calculation, the system may comprise a layered data flow structure, in which nodes of a higher layer call on a lower level system in accordance with the invention to calculate the SVD of the matrix representation of the restriction A|_{IS}, possibly using the transpose of this matrix as input to the lower level if advantageous. Each layer could progressively call on a lower level to calculate the SVD until the matrix for which an SVD is to be calculated is small enough to be calculated internally in a non-distributed manner. The number of layers required will depend on a number of factors, including the size of the original matrix, A, and size of the restriction A|_{IS} to subspace IS.

In one embodiment, each leaf node and branch node is arranged to calculate a q-leading part of the SVD of a m×1 matrix representation W with 1≧2q by:

initialising a matrix Q as a seed by the following equality:—

$$QR = qr ( {[ \begin{matrix}{W}_{1 , 1} & … & {W}_{1 , l} \\ ⋮ & ⋱ & ⋮ \\ {W}_{2 q , 1} & … & {W}_{2 q , l}\end{matrix} ]}^{T} ) ,$$

where W_{i,j} refers to the value in row i, column j of matrix W, and qr is a function implementing the QR-factorisation of a matrix, and iterating the following assignment until the normalised change in E is less than an error tolerance, ξ:

$$U Σ {V}^{T} = svd ( W Q ) , \\ X = Q [ \begin{matrix}{V}_{1 , 1} & … & {V}_{1 , q} \\ ⋮ & ⋱ & ⋮ \\ {V}_{2 q , 1} & … & {V}_{2 q , q}\end{matrix} ] , \\ {Q}^{′} {R}^{′} = qr ( {W}^{T} [ \begin{matrix}{U}_{1 , 1} & … & {U}_{1 , q} \\ ⋮ & ⋱ & ⋮ \\ {U}_{m , 1} & … & {W}_{m , q}\end{matrix} ] ) , \\ QR = qr ( [ X , [ \begin{matrix}{Q}_{1 , 1}^{′} & … & {Q}_{1 , q}^{′} \\ ⋮ & ⋱ & ⋮ \\ {Q}_{m , 1}^{′} & … & {Q}_{m , q}^{′}\end{matrix} ] ] ) .$$

This process of approximating the SVD of the matrix A is advantageous as it can be carried out based only on the data on matrix W. In this way, it may be possible to arrange the system such that once the node has received data that is sufficient to form the matrix W, no further data needs to be received. This method does use the invocation of another SVD internally, however this invocation is on the matrix WQ, which is far smaller than the original matrix W.

However, in some cases, the matrix WQ can still be extremely large. Accordingly, to further reduce the size of the matrix for which the actual SVD has to be calculated, each leaf node and branch node may be arranged to calculate the SVD of WQ by constructing matrices U′ and P′ such that:

U′P′=qr(WQ),

calculating the SVD of P′,

U″ΣV^{T}=P′,

and complete the SVD of WQ by constructing U with the statement U=U′U″, so that WQ=UΣV^{T}.
Matrix P′ is of size 2q×2q, much smaller than WQ, and therefore, a calculation to determine the actual SVD of P′ can be carried out much
faster than a calculation to determine the SVD of WQ.

In one arrangement, each leaf node is arranged to use the results of the calculations carried out by the leaf node to compute, for the subspace IS calculated by the leaf node, data indicative of the subspace OS of IS, and to pass the data indicative of OS and the corresponding restriction A|_{OS} of the linear map represented by A to one or a plurality of the branch nodes. Furthermore, the or each branch node may be arranged to use the results of the calculations carried out by the branch node to compute, for the subspace IS calculated by the branch node, data indicative of a subspace OS of IS and, if further processing of the data indicative of a subspace OS is required, to pass the data indicative of OS and the corresponding restriction A|_{OS} of A to one or a plurality of the subsequent (in terms of data flow) branch nodes.

One or a plurality of server nodes may be arranged to initiate calculations by leaf nodes before all the leaf nodes receive all the data on the first matrix, A. As the calculations carried out by the leaf nodes are independent of the calculations carried out by other leaf nodes, to initiate a leaf node requires only sufficient data to form the restriction A|_{IS} of the linear map represented by A on a local subspace IS. In the embodiment described above, where at each leaf node A|_{IS} is represented by a submatrix W consisting of columns selected from A, it is not necessary that all of A be known before the input of some of the leaf nodes is constructed and for them to start their calculation.

The independence of the nodes also allows calculations by nodes to be restarted if a node fails.

Accordingly, in one embodiment, each processor operating as one of the leaf and/or branch nodes is arranged to notify the or the plurality of server nodes of successful completion of a calculation and the server node is arranged to restart the calculation carried out by that node with another processor if the server node fails to receive notification of successful completion of a calculation from the original processor.

In another embodiment, each processor operating as one of the leaf and/or branch nodes is arranged to notify the or the plurality of server nodes of failure to complete a calculation and the server node is arranged to restart the calculation carried out by that node with another processor if the server node receives the notification of failure to complete a calculation from the original processor.

In another embodiment, multiple copies of each node computation are created and allowed to execute until such time as one completes.

The system may be a network of computers or a single computer comprising multiple processors and/or a multi-core processor.

The system may be adapted for the analysis of climate and weather data, in image processing (facial recognition, image compression, image deblurring etc.), data compression, finance (determine market-driving factors, covariance estimation techniques, finding locally-defined functional dependences between parameters etc.), model reduction for high-dimensional control systems, signal processing (noise reduction, multichannel fluctuation data analysis in fusion plasma devices etc.), in the regularisation of inverse problems, in solving linear least squares problems (used in linear regression, computing pseudoinverses of linear operators, computer tomography, geophysical inversion, seismology, oil exploration, fault diagnosis, medical imaging etc.), in pattern recognition, spectroscopy (analysis of time-resolved macromolecular x-ray data, small-angle scattering, etc.), modal analysis (vibration reduction, sound engineering etc.), information retrieval, latent semantic indexing, construction of search engines, detection of computer network attacks, microarray analysis, functional clustering, analysing gene expression profiles, gene recognition, molecular dynamics, solving systems of homogeneous linear equations, preconditioning of linear systems, determining dependencies or near-dependencies among the columns or rows of a matrix (used by optimisation software in the preprocessing of constraints in linearly constrained optimisation problems), and in numerous other contexts.

According to a second aspect of the invention there is provided a data carrier having instructions thereon that when executed by processors of a system causes the system to operate in accordance with the first aspect of the invention.

According to a third aspect of the invention there is provided a server arranged to, in response to a user request, cause a system comprising a plurality of processors to operate in accordance with the first aspect of the invention.

According to a fourth aspect of the invention, there is provided a leaf node comprising a processor arranged to obtain data indicative of the restriction A|_{IS} of a linear map from Rⁿ to R^{m} represented by a first matrix, A, to a subspace IS (henceforth referred to as a node input space) of Rⁿ of a linear map Rⁿ to R^{m}, represented by a first matrix, A, to carry out a calculation of data indicative of at least a leading part of the SVD of a matrix representation of A|_{IS}, to use the results of the calculation to compute, for the input subspace IS data indicative of a subspace OS (henceforth referred to as a node output space) of IS, and to pass the data indicative of OS and a corresponding restriction A|_{OS} of the linear map represented by A to a branch node. According to a fifth aspect of the invention, there is provided a data carrier having stored thereon instructions executable on a processor to cause the processor to obtain data indicative of the restriction A|_{IS} of a linear map from Rⁿ to R^{m} represented by a first matrix, A, to a subspace IS (henceforth referred to as a node input space) of Rⁿ, to carry out a calculation of data indicative of at least a leading part of the SVD of a matrix representation of A|_{IS}, to use results of the calculation to compute data indicative of a subspace OS (henceforth referred to as a node output space) of IS, and to pass data indicative of OS and the corresponding restriction A|_{OS} of the linear map represented by A to a branch node.

According to a sixth aspect of the invention, there is provided a branch node comprising a processor arranged to receive data indicative of node output subspaces OS₁, . . . , OSₖ and the corresponding restrictions A|_{OS1}, . . . , A|_{OSk} for k≧2 of a linear map from Rⁿ to R^{m} represented by a matrix A to subspaces OS₁, . . . , OSₖ, to use this data to form a further node input space IS=OS₁+ . . . +OSₖ, to calculate data indicative of a leading part of the SVD of a matrix representation of the restriction A|_{IS} of the linear map represented by A to the further node input space IS, to use results of the calculation to compute data indicative of a further node output space OS of IS and, if further processing of the data indicative of the further node output space OS is required, to pass the data indicative of the further node output space OS and a corresponding restriction A|_{OS} of A to a branch node.

According to a seventh aspect of the invention, there is provided a data carrier having stored thereon instructions executable on a processor to cause the processor to receive data indicative of node output subspaces OS₁, . . . , OSₖ and corresponding restrictions A|_{OS1}, . . . , A|_{OSk} for k≧2 of a linear map from Rⁿ to R^{m} represented by a matrix A to subspaces OS₁, . . . , OSₖ, to use this data to form a further node input space IS=OS₁+ . . . +OSₖ, to calculate data indicative of a leading part of the SVD of a matrix representation of the restriction A|_{IS} of the linear map represented by A to the further node input space IS, to use results of the calculations to compute data indicative of a further node output sub-space OS of IS and, if further processing of data indicative of the further node output space OS is required, to pass the data indicative of the further node output space OS and a corresponding restriction A|_{OS} of the linear map represented by A to one or a plurality of the branch nodes.

According to a eighth aspect of the invention, there is provided a server node comprising a processor arranged to receive data on a linear map from Rⁿ to R^{m} represented by a first matrix, A, to divide Rⁿ into a plurality of sub-spaces, IS, to compute data indicative of the restrictions A|_{IS} of the linear map represented by A to these subspaces, and to send data indicative of the plurality of sub-spaces, IS, and restrictions, A|_{IS}, to a plurality of leaf nodes such that each one of the plurality of leaf nodes receives data indicative of a sub-space, IS, and a corresponding restriction, A|_{IS}.

According to a ninth aspect of the invention, there is provided a data carrier having stored thereon instructions executable on a processor to cause the processor to receive data on a linear map from Rⁿ to R^{m} represented by a first matrix, A, to divide Rⁿ into a plurality of sub-spaces, IS, to compute data indicative of the restrictions A|_{IS} of the linear map represented by A to these subspaces, and to send data indicative of the plurality of sub-spaces, IS, and restrictions, A|_{IS}, to a plurality of leaf nodes such that each one of the plurality of leaf nodes receives data indicative of a sub-space, IS, and the corresponding restriction, A|_{IS}.

According to an tenth aspect of the invention, there is provided an evaluation node comprising a processor arranged to receive data indicative of a node output sub-space OS of Rⁿ and a restriction A|_{OS} of the linear map represented by the first matrix, A, to this space, to compute the p-leading part of the SVD of a matrix representation of A|_{OS}, and to use the results of this calculation to calculate an approximation of a p-leading part of the SVD of A, with p≦dim(OS)

In one embodiment, the evaluation node is arranged to receive data in the form of matrices Wₒᵤₜ, Qₒᵤₜ consistent with the embodiment of leaf and branch nodes described earlier. The evaluation node may be arranged to determine a p-leading part UΣ\tilde{V}^{T} of the SVD of Wₒᵤₜ, and to present the matrices U, Σ and V=Qₒᵤₜ \tilde{V} as the factors of an approximate p-leading part of the SVD of A.

According to a eleventh aspect of the invention, there is provided a data carrier having stored thereon instructions executable on a processor to cause the processor to receive data indicative of a node output sub-space OS of Rⁿ and a restriction A|_{OS} of the linear map represented by the first matrix A to this space, to compute the p-leading part of the SVD of a matrix representation of A|_{OS}, and to use the results of this calculation to calculate an approximation of a p-leading part of the SVD of A, with p≦dim(OS).

According to a twelfth aspect of the invention, there is provided a method of distributing the processing of a singular value decomposition (SVD) of a first matrix, the method comprising: operating each of a plurality of leaf nodes to receive data indicative of a restriction A|_{IS} of a linear map from Rⁿ to R^{m} represented by a first matrix, A, to a subspace IS of Rⁿ (henceforth referred to as a node input space), and to calculate data indicative of at least a leading part of the SVD of a matrix representation of A|_{IS}, operating one or more of the leaf nodes and/or one or more branch nodes to use results of the calculations carried out by the leaf nodes to compute, for each subspace IS calculated by the leaf nodes, data indicative of a subspace OS (henceforth referred to as the node output space) of IS, and to pass the data indicative of OS and the corresponding restriction A|_{OS} of the linear map represented by A to one or a plurality of the branch nodes, operating the or each branch node to receive data indicative of node output spaces OS₁, . . . , OSₖ and the corresponding restrictions A|_{OS1}, . . . , A|_{OSk} for k≧2, to use this data to form a further node input space IS=OS₁+ . . . +OSₖ, and to calculate data indicative of a leading part of the SVD of a matrix representation of the restriction A|_{IS} of the linear map represented by A to the node input space IS, and operating one or more of the branch nodes to use the results of the calculations carried out by the branch nodes to compute, for each further node input space IS, data indicative of a further node output space OS of IS and, if further processing of the data indicative of the further node output space OS is required, to pass the data indicative of OS and the corresponding restriction A|_{OS} of the linear map represented by A to one or a plurality of the branch nodes.

According to an thirteenth aspect of the invention, there is provided a method of approximating a singular value decomposition (SVD) of a first matrix, A, the method comprising:—

a) obtaining data indicative of restrictions A|_{IS} of a linear map from Rⁿ to R^{m}., represented by a first matrix, A, to subspaces IS of Rⁿ, (henceforth referred to as node input spaces),

b) calculating data indicative of at least a leading part of the SVD of a matrix representation of A|_{IS},

c) using the results of the calculations to compute, for each subspace IS, data indicative of a corresponding subspace OS (henceforth referred to as the node output space) of IS,

d) for a set of the calculated node output spaces OS₁, . . . , OSₖ and the corresponding restrictions A|_{OS1}, . . . , A|_{OSk} for k≧2, using this set to form a further node input space IS=OS₁+ . . . +OSₖ, and to calculate data indicative of the leading part of the SVD of a matrix representation of the restriction A|_{IS} of the linear map represented by A to the further node input space IS,

e) computing, for each further node input space IS, data indicative of a further node output space OS of IS, and

f) repeating steps (d) and (e) for the further node output spaces OS and corresponding restrictions A|_{OS} until a specified condition is met.

The specified condition may be when all node input spaces IS drawn from the first matrix A have been combined to extract a single node output space OS.

### BRIEF DESCRIPTION OF THE DRAWINGS

Embodiments of the invention will now be described, by example only, with reference to the accompanying drawings, in which:—

FIG. 1 is a diagrammatic view of a network in accordance with the invention;

FIG. 2 is a diagrammatic view of a possible computer in accordance with the invention;

FIG. 3 is a an outline of the flow of data for a tree with three nodes in accordance with the invention;

FIG. 4 is an outline of the flow of data within a branch node;

FIG. 5 is an outline of the flow of data within a leaf node; and

FIG. 6 is a diagram of a matrix illustrating one way in which a matrix can be restricted for calculation of an SVD in accordance with the invention in a two layer embodiment.

### DETAILED DESCRIPTION OF THE PREFERRED EMBODIMENTS

The invention concerns a system that is capable of calculating (approximating) leading vectors of a singular value decomposition (SVD) of a matrix, A, that can be interpreted as representing a linear map from Rⁿ to R^{m}.

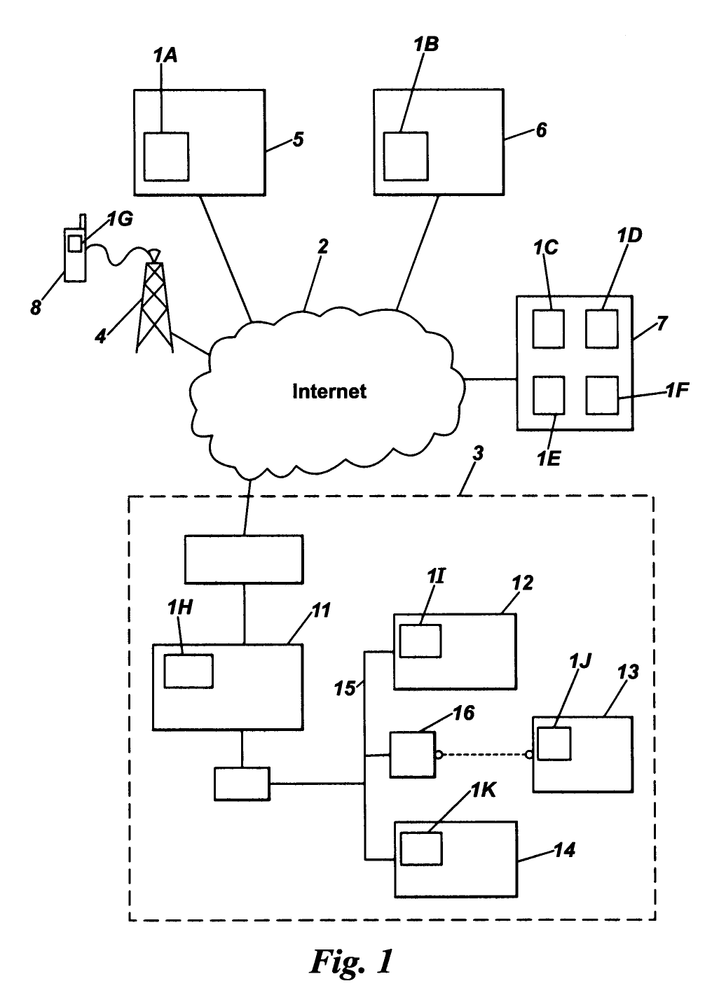

Referring to FIG. 1, in one embodiment, the system may comprise a network of processors 1A to 1K connected across networks 2, 3 and 4. In the embodiment shown, the system comprises individual computers 5, 6 and 7, computer 7 comprising multiple processors, a local area network 3 and a telecommunications network 4 connected to each other via the Internet 2. Telecommunications network 4 comprises telephone devices 8, such as mobile telephones, and LAN 3 comprises server 11 and computers 12 to 14 connected to the server 11 via cables 15 or wireless devices 16.

The computers 5 to 7, 12 to 14, telephone devices 8 and server 11 comprise processors 1A to 1K. Each processor 1A to 1K is capable of acting as a node within the system. One of the nodes, in this case processor 1A of computer 5, acts as a server node arranged to receive data on a first (original) matrix, A. On receiving data on the first matrix, the server node 1 A computes data indicative of restrictions A|_{IS} of the linear map defined by the first matrix to a number, k, of node input spaces IS, wherein k is two or more. In this embodiment, the node input spaces IS are spanned by coordinate vectors in Rⁿ, and the data indicative of A|_{IS} are submatrices of A. These sub-matrices are then sent to two or more of processors 1A to 1K operating as leaf nodes (Node 1A could act as a leaf node as well as a server node). The server node may begin generating sub-matrices and sending the completed sub-matrices to leaf nodes after receiving all of the data on the first matrix or may begin generating sub-matrices and sending the completed sub-matrices to leaf nodes as soon as the server node has received enough information on the first matrix to generate at least one sub-matrix.

It will be understood that in another embodiment, the data of the first matrix, A, may already be distributed as a set of sub-matrices, and it is then not necessary for the server node to receive data on matrix A and generate sub-matrices. However, a server node may still be required to instruct the nodes on where to obtain data on the node input spaces IS and the restrictions A|_{IS}, on how to process that data and/or on where to send the processed data.

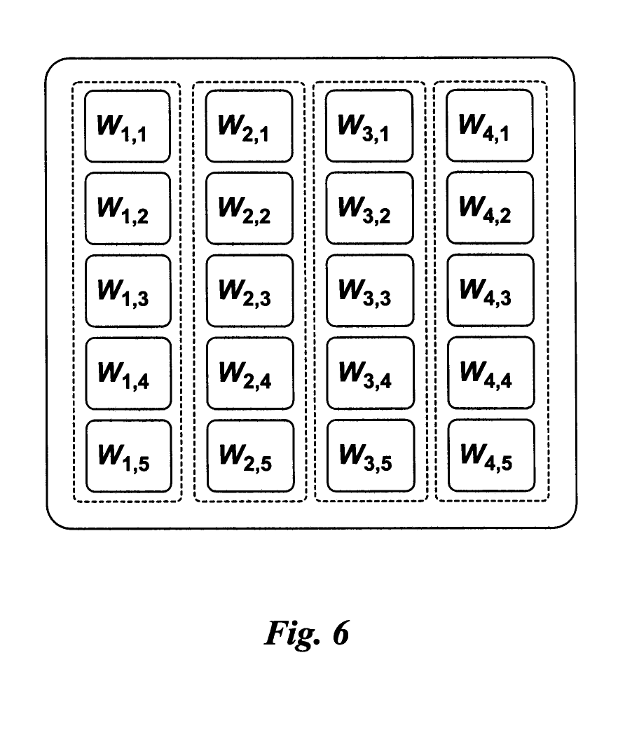

An example of a restriction of a first matrix to sub-spaces is shown in FIG. 6, wherein a matrix is divided into 20 sub-matrices W_{1,1} to W_{4,5}.

Each one of the leaf nodes is arranged to calculate data indicative of a p-leading part of the singular value decomposition (SVD) of a matrix representation of the received restriction, A|_{IS}, in this case represented by the sub-matrices W_{1,1} to W_{4,5}. One way of carrying out this calculation is described below. Once the calculation is carried out, each leaf node passes the data to a branch node, each one of the one or more branch nodes receiving the data from at least two leaf and/or branch nodes.

A branch node could be any one of processors 1A to 1K, and one or more of the processors 1A to 1K could act as branch node. Each branch node is arranged to generate, from the data received from other leaf or branch nodes, a further node input space IS, and to calculate further data indicative of at least a leading part of the SVD of a matrix representation of the restriction A|_{IS} corresponding to the further node input space.

For example, in the embodiment wherein the matrix A is divided into sub-matrices, if the branch node received data from leaf nodes that had processed sub-matrices W_{1,1} and W_{1,2}, the calculations carried out by the branch node are indicative of a leading part of the SVD of the sub-matrix formed by the combination of W_{1,1} and W_{1,2}.

If required, the branch nodes pass the further data to further branch nodes and the one or more further branch nodes generate, from the received data, yet further node input spaces IS and calculate yet further data indicative of at least the leading part of the SVD of a matrix representation of the restriction A|_{IS} corresponding to the node input space IS.

The data indicative of the SVD of the whole of the first matrix may then be used to construct approximate values of the SVD of the first matrix, namely U, Σ and V.

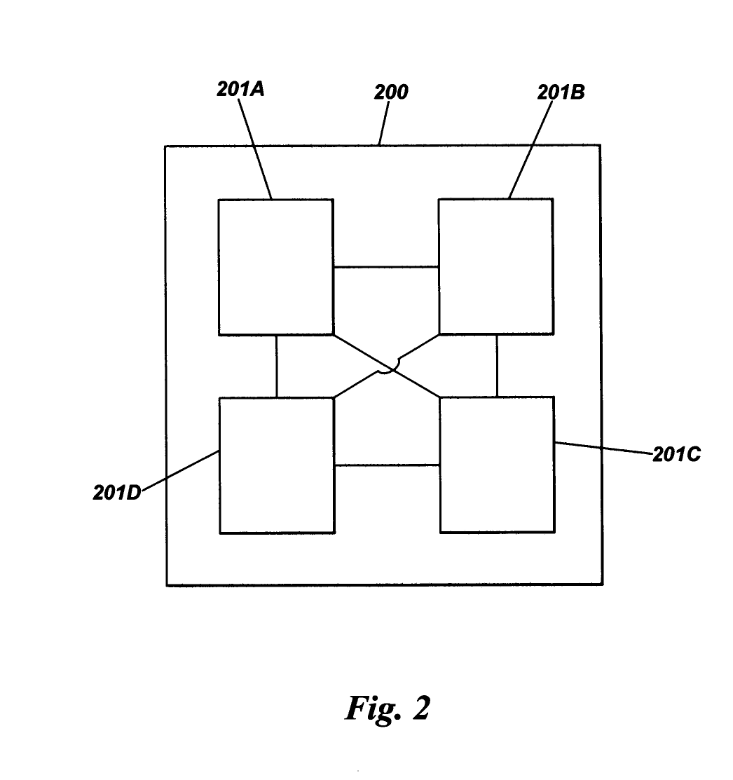

It will be understood that the invention is not limited to a distributed network of processing nodes as shown in FIG. 1, but could by applied in a non-distributed network of nodes, for example a computer comprising multiple processors as shown in FIG. 2 or even on a computer comprising a single processor.

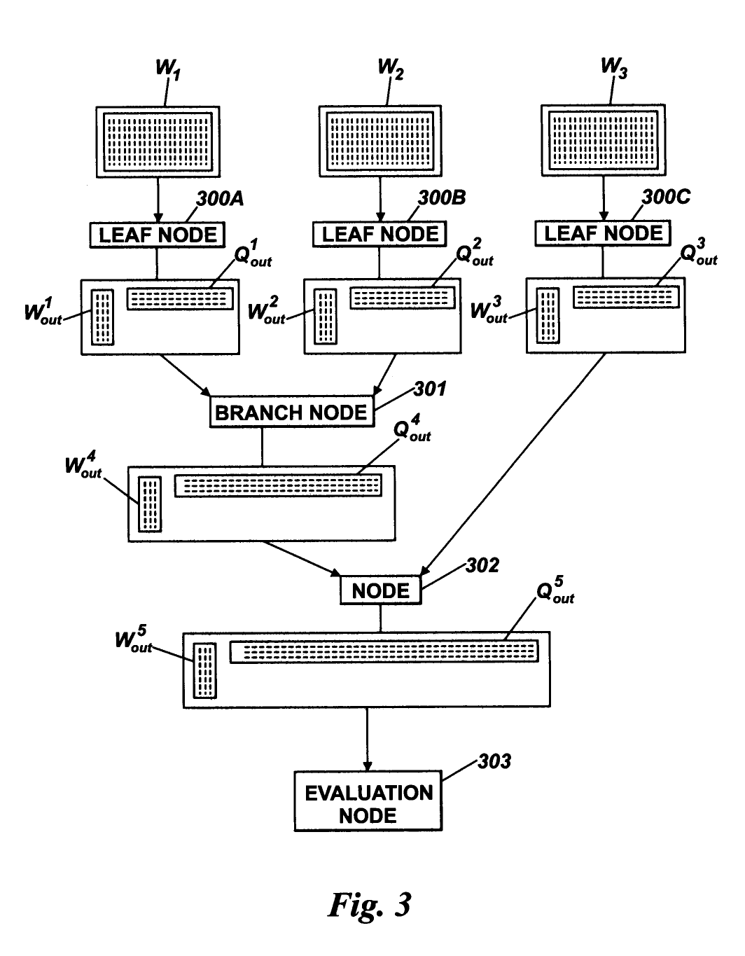

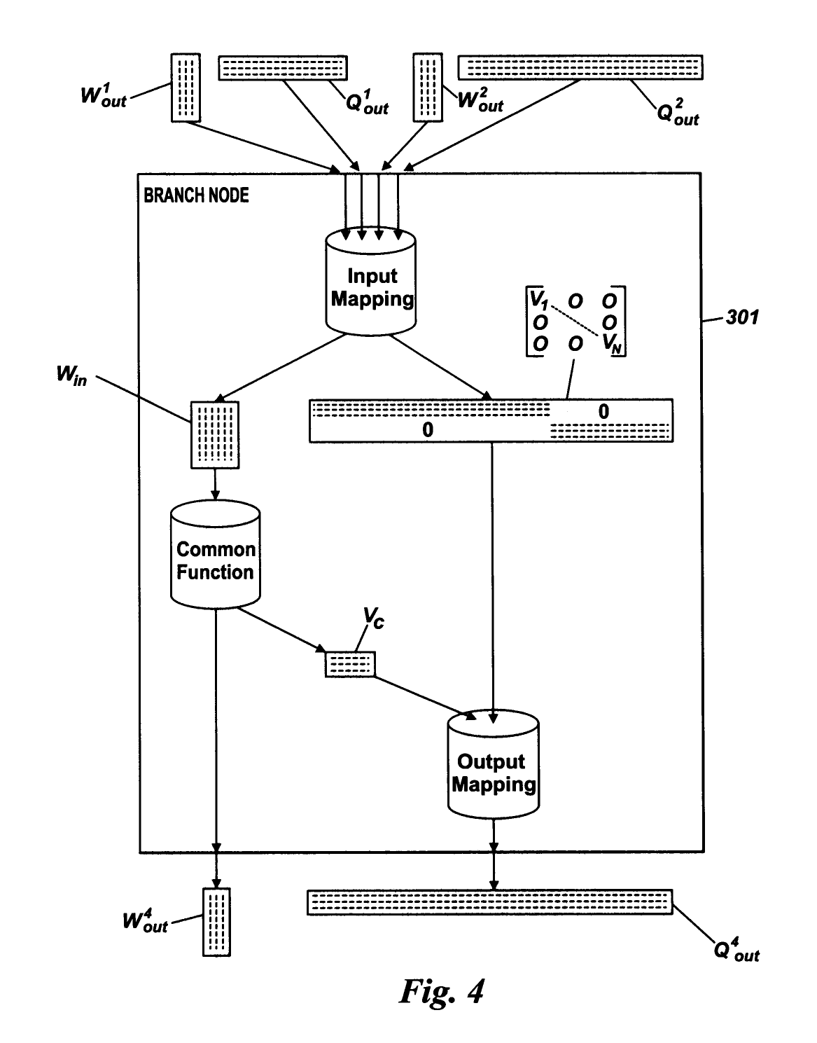

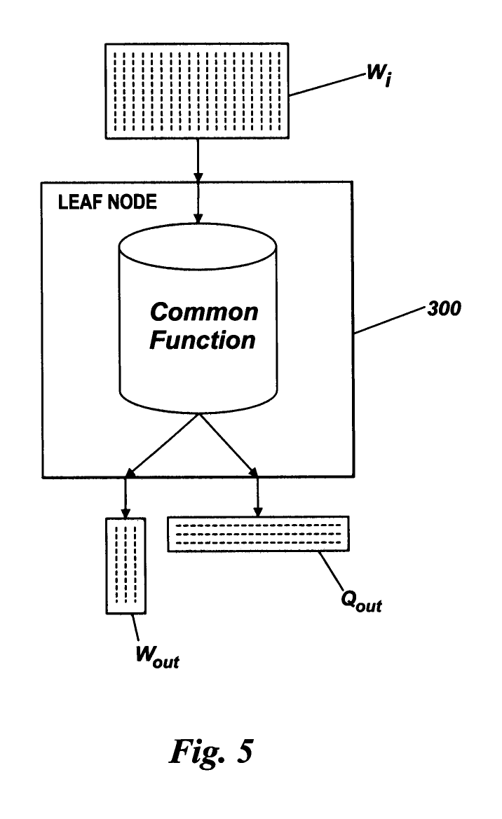

Further details of this embodiment of the invention will now be described with reference to FIGS. 3 to 6.

FIG. 3 illustrates a tree structure of data flow in accordance with an embodiment of the invention. As described above, the server node divides a first matrix into sub-matrices, A₁ to A₃, and these sub-matrices are sent to leaf nodes 300A to 300C.

### Leaf Nodes

Each leaf node 300A to 300C calculates data indicative of the p leading values of the SVD of a matrix representation of the restriction of the linear map represented by the first matrix, A, to sub-spaces, in this case, the SVD of the sub-matrices W₁, W₂ or W₃ sent to it from the server node. The calculation (referred to hereinafter as the common function) requires an input of a m×1 matrix Wᵢₙ and returns two matrices W and V equivalent to UΣ and V respectively, where UΣV^{T} is a p-leading part of the SVD of Wᵢₙ, these matrices therefore being indicative a p-leading part of the SVD of Wᵢₙ.

The common calculation comprises an iterative calculation that relies on a factorisation of the sub-matrix called the QR factorisation. In the QR factorisation, the sub-matrix Wᵢₙ, is factorised into matrices Q and R where Q is a matrix with orthonormal columns and R is an upper triangular matrix.

A matrix Q may be initialised as a seed by the following equality:—

$$QR = qr ( {[ \begin{matrix}{W}_{1 , 1} & … & {W}_{1 , l} \\ ⋮ & ⋱ & ⋮ \\ {W}_{2 q , 1} & … & {W}_{2 q , l}\end{matrix} ]}^{T} ) ,$$

where W_{i,j} refers to the values in row i, column j of the sub-matrix Wᵢₙ and qr is a function implementing the QR factorisation.

The following assignments are then iterated by the leaf node until the normalised change in Σ is less than an error tolerance ξ.

UΣV^{T}=svd(WᵢₙQ),

$$X = Q [ \begin{matrix}{Z}_{1 , 1} & … & {Z}_{1 , q} \\ ⋮ & ⋱ & ⋮ \\ {Z}_{2 q , 1} & … & {Z}_{2 q , q}\end{matrix} ] , \\ {Q}^{′} {R}^{′} = qr ( {W}_{in}^{T} [ \begin{matrix}{U}_{1 , 1} & … & {U}_{1 , q} \\ ⋮ & ⋱ & ⋮ \\ {U}_{m , 1} & … & {U}_{m , q}\end{matrix} ] ) , \\ QR = qr ( [ X , [ \begin{matrix}{Q}_{1 , 1}^{′} & … & {Q}_{1 , q}^{′} \\ ⋮ & ⋱ & ⋮ \\ {Q}_{l , 1}^{′} & … & {Q}_{l , q}^{′}\end{matrix} ] ] ) ,$$

This calculation does use an invocation of another SVD internally, but this invocation is a matrix WQ having a rank of n×2q, so far smaller than the original matrix Wᵢₙ.

However, for some calculations, the matrix WᵢₙQ may still be too large for a single node to calculate the SVD of WᵢₙQ. Accordingly, it is desirable to reduce the complexity of the calculation further, and this can be done because the shape of Q is known and, in such situations, q<<m and q<<n. To reduce the complexity, matrices U′ and P′ are computed, where

U′P′=qr(WᵢₙQ).

Then the SVD U″ΣV^{T} of P′ is computed, and finally the matrix product U=U′U″ is computed, and U, Σ and V^{T} are presented as the factors of the SVD of WᵢₙQ. This reduces the complexity for the internal SVD calculation carried out by the node, because P′ is a 2q×2q matrix which may be much smaller than either the matrix Wᵢₙ, or the matrix WᵢₙQ. Accordingly, this additional step may significantly increase the speed of calculation of the SVD of Wᵢₙ compared to simply determining this SVD through conventional means.

Once Σ has sufficiently converged in the core iteration such that the normalised change in Σ less than an error tolerance, τ, the leaf node generates values of W and V by the assignments:

$$V = [ \begin{matrix}{Q}_{1 , 1} & … & {Q}_{1 , q} \\ ⋮ & ⋱ & ⋮ \\ {Q}_{l , 1} & … & {Q}_{l , q}\end{matrix} ] , \\ W = {W}_{in} V .$$

In this embodiment, V and W comprise data indicative of a q-leading part of the SVD of the matrix Wᵢₙ passed to the leaf node. Next, the leaf node computes the output Qₒᵤₜ=Qᵢₙ V, Wₒᵤₜ=W, using the input data Qᵢₙ, Wᵢₙ and the results W, V of the common function applied to Wᵢₙ. This data is indicative of the node output space OS=span(Qₒᵤₜ) and the corresponding restriction A|_{OS} of the linear map represented by A. As shown in FIG. 3, the leaf nodes 300A and 300B send Qₒᵤₜ¹ and Wₒᵤₜ¹ and Qₒᵤₜ² and Wₒᵤₜ² respectively, to branch node 301. Leaf node 300C sends Qₒᵤₜ³ and Wₒᵤₜ³, to an extraction node 302.

It will be understood that the invention is not limited to the leaf nodes 300A to 300C carrying out the assignments of Qₒᵤₜ and Wₒᵤₜ. For example, in one embodiment, the leaf node may pass values of sub-matrix Wᵢₙ and Q to the branch/root node and the branch/root node generates values of V, Qₒᵤₜ and Wₒᵤₜ from Wᵢₙ and Q.

It will be understood that the extraction node 302 is a special kind of branch node as it is the final branch node in the tree and so occurs in a position in the graph to which data from all leaf nodes can flow. The description hereinafter with reference to the branch node also applies to the extraction node 302.

### Branch Nodes

Each branch node may receive values of Qₒᵤₜⁱ and Wₒᵤₜⁱ, or other values indicative of the leading parts of the SVDs of the matrices W₁, W₂, W₃, representing restrictions A|_{IS} of the linear map represented by the first matrix, A, to sub-spaces IS of Rⁿ, from two or more preceding nodes. These preceding nodes may be leaf nodes 300A to 300C and/or branch nodes 301. In FIG. 3, each branch node 301, 302 is shown as having two preceding nodes, the preceding nodes for branch node 301 being the two leaf nodes 300A and 300B and the preceding nodes of branch node 302 being leaf node 300C and branch node 301. The number of preceding nodes that feed into any one branch node 301, 302 will depend on the size of the matrices, the performance of the various systems and the desired performance of the parallel processing of the SVD. However, it will be understood that the branch nodes 301, 302 may receive values from more than two preceding nodes.

Each branch node 301, 302 receives data indicative of Wₒᵤₜ and Qₒᵤₜ from each of its preceding nodes among 300A to 300C, 301. On receiving this data, the branch node generates a matrix, Wᵢₙ, representing the restriction A|_{IS} of the linear map represented by A to a new sub-space IS of Rⁿ by juxtaposing the received matrices Wₒᵤₜ using the assignment:

Wᵢₙ=[W¹ₒᵤₜ . . . W^{k}ₒᵤₜ],

where W¹ₒᵤₜ to W^{k}ₒᵤₜ represent the values of WOut received from each preceding node from 1 to k. The branch node 301 (respectively 302) then carries out the common function, described with respect to the leaf nodes, on the new matrix, Wᵢₙ. This returns values of W and V for the new matrix Wᵢₙ. These values are then used to compute the values of Wₒᵤₜ and Qₒᵤₜ to be returned by the branch node via the following assignments:

$$Y = [ \begin{matrix}{Q}_{out}^{1} & 0 & 0 \\ 0 & ⋱ & 0 \\ 0 & 0 & {Q}_{out}^{k}\end{matrix} ] V , \\ {Q}_{out} R = qr ( Y ) , \\ {W}_{out} = {WR}^{- 1} .$$

In the event that the matrix Y is already orthogonal, for example if the dataflow graph is a tree and the matrices Wⁱᵢₙ passed to the leaf nodes correspond to sub-matrices of A with non-overlapping columns, the qr factorisation is unnecessary and R can be set to the identity matrix. The values of Wₒᵤₜ and Qₒᵤₜ returned by the branch node can then be passed to a further branch node down the dataflow tree, or, for the extraction node, returned to an evaluation node. In the embodiment of FIG. 3, branch node 301 passes its values of Wₒᵤₜ and Qₒᵤₜ to extraction node 302 whereas extraction node 302 passes its values of Wₒᵤₜ and Qₒᵤₜ to the evaluation node 303.

The extraction node 302 of the dataflow tree also passes the data on Σ to the evaluation node 303.

Once m×1 and n×1 matrices Wₒᵤₜ and Qₒᵤₜ have been produced at an extraction node, with 1≧p, to obtain data indicative of the p-leading part UΣV^{T} of the SVD of the first matrix, A, the evaluation node 303 takes Σ passed to it by the extraction node 303 and crops it to its leading p×p block, computes U by the statement,

$$U = [ \begin{matrix}{W}_{1 , 1} & … & {W}_{1 , p} \\ ⋮ & ⋱ & ⋮ \\ {W}_{m , 1} & … & {W}_{m , p}\end{matrix} ] {\sum }^{- 1} ,$$

where W_{i,j} refers to the value in row ti, column j, of the matrix Wₒᵤₜ, and assigns V=Qₒᵤₜ. The system has then completed an approximation to the SVD of the leading p vectors and values of the first matrix, A.

The system of the invention may be advantageous as the SVD of the first matrix can be approximated by parallel processing the SVD across a plurality of nodes with loose coupling between the nodes, i.e. each node can complete its calculations independently of nodes in a different branch of the dataflow tree. Furthermore, once a node has completed a calculation of the SVD of a matrix representation of the restriction A|_{IS} of the linear map represented by A to a sub-space IS of Rⁿ and passed the data to a branch node, the node is free to be used for processing of another calculation (or even another task altogether). Accordingly, a processor 1A to 1K of the system can act as one or more leaf nodes, one or more branch nodes, server node and evaluation node within the dataflow tree. For example, processor 1A could carry out the task of leaf node 300A in FIG. 3 and, on completing the task, carry out the task of branch node 301. Alternatively or additionally, a processor could carry out the task of two leaf nodes, for example leaf node 300A and 300C. In this way, the processors 1A to 1K can be allocated to tasks as and when they become available.

This loose coupling also has the advantage that if a node on one branch fails or is very slow, this will not affect tasks carried out by other nodes or the completion of the evaluation along another branch of the dataflow tree. Furthermore, the tasks of this node may be easily allocated to or restarted on another processor without affecting the tasks carried out by other nodes.

As the dataset of the first matrix is broken down into a large number of independent pieces, it is not necessary that the dataset be complete at the time the system initialises the calculations by the leaf nodes as new data can be added to the dataflow tree in the form of a new leaf node at any time. This has particular advantages when the parts of the first matrix are updated, as instead of performing the calculation on the entire matrix, the new data can be combined with existing results from other branches of the dataflow tree, so that the calculation converges to the leading part of the SVD of the updated matrix A more rapidly and without necessarily still having access to the rest of the first matrix A.

Each node calculates the leading q-dimensional subspace under the mapping represented by the matrix W processed by the node. At each stage, information is lost as only the q-leading values of the SVD of each matrix W are retained. Therefore, for some situations, it is possible for the system not to return the p-leading subspace for the first (original) matrix, A. There are two ways in which this can be mitigated.

The first option, after evaluating the entire dataflow tree once, is to restart the calculation at each leaf node 300A to 300C, now using each of these nodes as a branch node taking as input its original data as well as the output of the last iteration of the extraction node 302. In this way, the most significant information from the merged results from all the leaf nodes is fed back into the calculation.

The second option is to increase the value of p to a slightly larger value than required. This results in the calculation of additional vectors and these additional vectors may carry sufficient additional information to ensure that the system returns the largest possible subspace for the first (original) matrix. These extra vectors can then be discarded once the evaluation of the tree has been completed. Whether this second option is feasible and the number of excess vectors required (how much the value of p needs to be increased) will depend on a number of factors including how distinct the singular vectors of the first matrix are.

It will be understood that the invention is not limited to the above described embodiments, but modifications and alterations are possible to the described embodiment without departing from the scope of the invention as defined herein.

For example, the system may comprise a different number of nodes to that shown in the drawings (in most cases a much larger number of nodes) and the dataflow structure will also differ accordingly.

In one embodiment the system comprises a registering system in which users register their computer with the server node as a resource to be used in the system of the invention. In such a system, data output from a node may be passed to other nodes via the server node. Registering a computer as a resource to be used as part of the system may allow the user to use the system to calculate the SVD of a matrix.

In one embodiment, the nodes are arranged such that data on the calculation of the SVD is passed between the nodes in a directed acyclic graph dataflow structure. In such an arrangement, the system does not comprise a single extraction node, but multiple extraction nodes. By having such an arrangement, computation is not limited by the resources of a single extraction node.

It will be understood that the intention is for the invention to determine the p-leading parts of an SVD, but the invention is not limited to this but could also be used to determine the full SVD, or the spectral decomposition of a symmetric matrix, both of which are special cases of p-leading parts of an SVD.

What is claimed is:

1. A system comprising a plurality of leaf nodes in communication with one or more branch nodes, each node comprising a processor, each of the plurality of leaf nodes arranged to obtain data indicative of a restriction A|_{IS} is of a linear map from Rⁿ to R^{m} represented by a first matrix, A, to a subspace IS of Rⁿ (henceforth referred to as a node input space) and to carry out a calculation of data indicative of at least a leading part of a SVD of a metric representation of the restriction A|_{IS},
one or more of the plurality of leaf nodes and the one or more branch nodes is arranged to use results of the calculations carried out by the plurality of leaf nodes to compute data indicative of a subspace OS (henceforth referred to as a node output space) of each node input space IS, and to pass the data indicative of node output space OS and a corresponding restriction A|_{OS} of A to one or a plurality of the one or more branch nodes,
each of the one or more branch nodes is arranged to receive data indicative of node output spaces OS₁, . . . , OSₖ and the corresponding restrictions A|_{OS1}, . . . , A|_{OSk} for k≧2, to use the data to form a further node input space IS=OS₁+ . . . +OSₖ, and to carry out further calculation of data indicative of the leading part of the SVD of a matrix representation of a further restriction A|_{IS} of the linear map A to the further node input space IS, and
one or more of the one or more branch nodes arranged to use results of the further calculations carried out by the one or more branch nodes to compute data indicative of a further node output space OS of the further node input space IS and, if further processing of the data indicative of a further node output space OS is required, to pass the data indicative of the further node output space OS and a corresponding restriction A|_{OS} of the linear map represented by A to one or a plurality of the one or more branch nodes.

2. A system according to claim 1, wherein the node input space IS of each of the plurality of leaf nodes is represented via an orthogonal basis given by the columns of a Stiefel matrix Qᵢₙ of size n×1 (for Q to be Stiefel it is required that Q^{T}Q=I), and data indicative of the restriction A|_{IS} is represented by a matrix Wᵢₙ that approximates a product AQᵢₙ.

3. A system according to claim 2, wherein each of the plurality of leaf nodes is arranged to calculate an m-leading part Wᵢₙ=UΣV^{T} of Wᵢₙ for m≦1, and determine the node output space OS via an orthogonal basis given by the columns of the Stiefel matrix Qₒᵤₜ=Qᵢₙ V and the restriction A|ₒₛ by the matrix Wₒᵤₜ=Wᵢₙ V, approximating AQₒᵤₜ.

4. A system according to claim 1, wherein each of the one or more branch nodes is arranged to generate the further node input space IS by forming a matrix Qᵢₙ=Diag(Qₒᵤₜ¹, . . . , Qₒᵤₜ^{k}) obtained by arranging matrices Qₒᵤₜⁱ in diagonal blocks, where Qₒᵤₜⁱ are the n×1ᵢ Stiefel matrices that represent the node output spaces of the leaf and/or branch nodes from where the input data of the current branch node are received.

5. A system according to claim 3, wherein, each of the one or more branch nodes is arranged to determine the further restriction A|_{IS} of the linear map, represented by the first matrix A, to the node input space by the juxtaposition of matrices Wᵢₙ=[Wₒᵤₜ¹, . . . , Wₒᵤₜ^{k}], where Wₖⁱ, are the matrices representing the restriction of A to the node output spaces received by the branch node, a m-leading part Wᵢₙ=USV^{T} of Wᵢₙ for m≦l₁+ . . . +lₖ, the QR-decomposition QₒᵤₜR of the product of matrices [I, . . . , I]Qᵢₙ V, where I are identity matrices of size n, the node output space OS is represented via the orthogonal basis given by the columns of the Stiefel matrix Qₒᵤₜ, and the restriction A|_{OS} is represented by the matrix Wₒᵤₜ=Wᵢₙ VR⁻¹, approximating AQₒᵤₜ.

6. A system according to claim 1, wherein each of the plurality of leaf nodes and/or the one or more branch nodes is arranged to calculate a predetermined, user specified or dynamically adjusted number, m≦dim(IS), of leading vectors of the SVD of a matrix representation of the or the further restriction A|_{IS} of the linear map corresponding to matrix A to the or the further node input space IS.

7. A system according to claim 1, wherein each of the plurality of leaf nodes and/or the one or more branch nodes is arranged to calculate the full SVD of a matrix representation of the or the further restriction A|_{IS} of the linear map corresponding to matrix A to the or the further node input space IS.

8. A system according to claim 1, wherein each of the plurality of leaf nodes and the one or more branch nodes is arranged to calculate the SVD of a matrix representation of the or the further restriction A|_{IS} of A onto the relevant node input space by:
initialising a matrix Q as a seed by the following equality:—
$$QR = qr ( {[ \begin{matrix}{W}_{1 , 1} & … & {W}_{1 , 2 p} \\ ⋮ & ⋱ & ⋮ \\ {W}_{m , 1} & … & {W}_{m , 2 p}\end{matrix} ]}^{T} ) ,$$
where W_{i,i} refers to the values in row i, column i of matrix Wᵢₙ relating to the restriction A|_{IS}, and qr is a function implementing the QR-factorisation of a matrix, and
iterating the following assignment until the normalised change in Σ is less than a predetermined error tolerance, ξ
$$U Σ {V}^{T} = svd ( WQ ) , \\ X = Q [ \begin{matrix}{V}_{1 , 1} & … & {V}_{1 , p} \\ ⋮ & ⋱ & ⋮ \\ {V}_{2 p , 1} & … & {V}_{2 p , p}\end{matrix} ] , \\ {Q}^{′} {R}^{′} = qr ( {W}^{T} [ \begin{matrix}{U}_{1 , 1} & … & {U}_{1 , p} \\ ⋮ & ⋱ & ⋮ \\ {U}_{m , 1} & … & {U}_{m , p}\end{matrix} ] ) , \\ QR = qr ( [ X [ \begin{matrix}{Q}_{1 , 1}^{′} & … & {Q}_{1 , p}^{′} \\ ⋮ & ⋱ & ⋮ \\ {Q}_{m , 1}^{′} & … & {Q}_{m , p}^{′}\end{matrix} ] ] ) ,$$

9. A system according to claim 8, wherein each of the plurality of leaf nodes and the one or more branch nodes is arranged to calculate the SVD of WQ by constructing matrices U′ and P′ such that:
U′P′=qr(WQ),
calculating the SVD of P′ such that:
U″ΣV^{T}=svd(P′), and
complete the SVD of U′ by constructing U with the statement U=U′U″.

10. A system according to claim 1, wherein each of the plurality of leaf nodes is arranged to use the results of the calculations carried out by that leaf node to compute data indicative of a node output subspace OS of the node input subspace IS received by that leaf node, and to pass the data indicative of node output subspace OS and the corresponding restriction A|_{OS} of A to one or a plurality of the one or more branch nodes.

11. A system according to claim 8, wherein each of the plurality of leaf nodes is arranged to use the results of the calculations carried out by that leaf node to compute data indicative of a node output subspace OS of the node input subspace IS received by that leaf node, and to pass the data indicative of node output subspace OS and the corresponding restriction A|_{OS} of A to one or a plurality of the one or more branch nodes and each leaf node is arranged to, once Σ has converged in the iteration such that the normalised change in Σ is less than a predetermined error tolerance, ξ, generates values of Wₒᵤₜ and Vₒᵤₜ by the assignments:
$${V}_{out} = [ \begin{matrix}{Q}_{1 , 1} & … & {Q}_{1 , p} \\ ⋮ & ⋱ & ⋮ \\ {Q}_{m , 1} & … & {Q}_{m , p}\end{matrix} ] , \\ {W}_{out} = {W}_{in} [ \begin{matrix}{Q}_{1 , 1} & … & {Q}_{1 , p} \\ ⋮ & ⋱ & ⋮ \\ {Q}_{m , 1} & … & {Q}_{m , p}\end{matrix} ] ,$$

12. A system according to claim 11, wherein each leaf node is arranged to compute Qₒᵤₜ=Qᵢₙ V. and pass Qₒᵤₜ and Wₒᵤₜ to one of the one or more branch nodes.

13. A system according claim 1, wherein the plurality of leaf nodes and the one or more branch nodes are arranged such that the data flows between the nodes in a directed (network) graph structure.

14. A system according to claim 13, wherein the dataflow structure is a directed tree, the root of which is the unique extraction node.

15. A system according to claim 14, wherein the system further comprises an evaluation node, comprising a processor, arranged to receive data indicative of the or the further node output space OS of an extraction node and the or the further restriction A|_{OS} of the linear map represented by the first matrix A to this space, and to calculate an approximation of the p-leading part of the SVD of A, with p≦dim(OS).

16. A system according to claim 15, wherein output data of an extraction node is received by the evaluation node in the form of matrices Wₒᵤₜ, Qₒᵤₜ.

17. A system according to claim 17, wherein the evaluation node is arranged to determine p-leading part of the SVD Wₒᵤₜ=UΣ\tilde{V}^{T} of WOut and the factors U, Σ and V=Qₒᵤₜ\tilde{V} are presented as the factors of the approximate p-leading SVD of the first matrix, A.

18. A system according to claim 11, wherein output data of an extraction node is received by the evaluation node in the form of matrices Wₒᵤₜ, Qₒᵤₜ and the evaluation node determines Σ from a value Σ passed to the evaluation node by the extraction node and determines U from the value of I and a matrix W passed to the evaluation node from the extraction node in accordance with:
U=WΣ⁻¹,
wherein matrix W is proportional to the product of output matrix U and diagonal matrix Σ of the SVD calculated by the extraction node.

19. A system according to claim 1, comprising one or a plurality of server nodes arranged to initiate calculations by the leaf nodes and wherein the one or a plurality of server nodes are arranged to initiate calculations by the leaf nodes before all the data on the first matrix, A, has been received by the server and/or leaf nodes.

20. A system according to claim 1, comprising one or a plurality of server nodes arranged to initiate calculations by the leaf nodes and wherein each processor operating as one of the plurality of leaf nodes and/or the one or more branch nodes is arranged to notify the server node of successful completion of the or the further calculation and the server node is arranged to restart the or the further calculation carried out by that node with another processor if the server node fails to receive notification of successful completion of the or the further calculation from the original processor.

21. A system according to claim 1, comprising one or a plurality of server nodes arranged to initiate calculations by the leaf nodes, and wherein each processor operating as one of the plurality of leaf nodes and/or the one or more branch nodes is arranged to notify the server node of failure to complete the further calculation and the server node is arranged to restart the or the further calculation carried out by that node with another processor if the server node receives the notification of failure to complete the or the further calculation from the original processor.

22. A data carrier having instructions thereon that when executed by processors of a system causes the system to operate in accordance with claim 1.

23. A server arranged to, in response to a user request, cause a system comprising a plurality of processors to operate in accordance with claim 1.

24. A leaf node comprising a processor arranged to arranged to obtain data indicative of a restriction A|_{IS} of a linear map from Rⁿ to R^{m} represented by a first matrix, A, to a subspace IS (henceforth referred to as the node input space) of Rⁿ of a first matrix, A, to calculate data indicative of at least a leading part of the SVD of A|_{IS}, to use the results of the calculation to compute, for the node input space, data indicative of a subspace OS (henceforth referred to as a node output space) of IS, and to pass the data indicative of OS and a corresponding restriction A|_{OS} of A to a branch node.

25. A data carrier having stored thereon instructions executable on processor to cause the processor to operate as a leaf node in accordance with claim 24.

26. A branch node comprising a processor arranged to receive data indicative of node output subspaces 0S₁, . . . , 0Sₖ and corresponding restrictions A|_{OS1}, . . . , A|_{OSk}, for k≧2 of a linear map from Rⁿ to R^{m} represented by a matrix A to subspaces OS₁, . . . , OSₖ, to use this data to form a further node input space IS=OS₁+ . . . +0Sₖ, to calculate data indicative of the leading part of the SVD of a matrix representation of a restriction A|_{IS} of the linear map A to the further node input space IS, to use results of the calculation to compute data indicative of a further node output space OS of IS and, if further processing of the data indicative of the further node output space OS is required, to pass data indicative of the further node output space OS and a corresponding restriction A|_{OS} of A to a branch node.

27. A data carrier having stored thereon instructions executable on processor to cause the processor to operate as a branch node in accordance with claim 26.

28. A server node comprising a processor arranged to receive data on a first matrix, divide the first matrix into a plurality of sub-spaces, IS, in accordance with restrictions A|_{IS}, wherein the first matrix, represents a linear map from Rⁿ to R^{m}, and send the plurality of sub-spaces, IS, to a plurality of leaf nodes such that each one of the plurality of leaf nodes receives a sub-space, IS.

29. A data carrier having stored thereon instructions executable on processor to operate as a server in accordance with claim 28.

30. An evaluation node comprising a processor arranged to receive data indicative of node output space OS and restriction A|_{OS} of a linear map from Rⁿ to R^{m} represented by the first matrix A to the node output space OS, and to calculate an approximation of a p-leading part of the SVD of A, with p≦dim(OS).

31. A data carrier having stored thereon instructions executable on processor to cause the processor to operate as an evaluation node in accordance with claim 30.

32. A method of distributing the processing of a singular value decomposition (SVD) of a first matrix, the method comprising:
operating each of a plurality of leaf nodes to receive data indicative of the restriction A|_{IS} of a linear map from Rⁿ to R^{m} represented by a first matrix, A, to a subspace IS (henceforth referred to as the node input space Rⁿ to R^{m}) of Rⁿ of a first matrix, A, and to calculate data indicative of at least a leading part of the SVD of A|_{IS},
operating one or more of the leaf nodes and/or one or more branch nodes to use results of the calculations carried out by the leaf nodes to compute, for each subspace IS calculated by the leaf nodes, data indicative of a subspace OS (henceforth referred to as the node output space) of IS, and to pass the data indicative of OS and a corresponding restriction A|_{OS} of A to one or a plurality of the branch nodes,
operating the or each branch node to receive data indicative of node output spaces OS₁, . . . , OSₖ and the corresponding restrictions A|_{OS1}, . . . , A|_{OSk} for K≧2, to use this data to form a further node input space IS=OS₁+ . . . +OSₖ, and to calculate data indicative of the leading part of the SVD of a matrix representation of a further restriction A|_{IS} of the linear map A to the further node input space IS, and
operating one or more of the branch nodes to use the results of the calculations carried out by the branch nodes to compute, for each further node input space IS, data indicative of a further node output space OS of IS and, if further processing of the data indicative of the further node output space OS is required, to pass the data indicative of OS and a corresponding restriction A|_{OS} of A to one or a plurality of the branch nodes.
